(19) United States
(12) Patent Application Publication
(10) Pub. No.: US 2020/0113190 A1
(43) Pub. Date: Apr. 16, 2020

(54) HIGH-FAT MIXTURES AND USES THEREOF

(71) Applicant: SHARON PURATOS LTD., Ashdod (IL)

(72) Inventors: Rachamim PALOMBO, Kiriat Tiveon (IL); Itay SHLAMKOVICH, Holon (IL)

(21) Appl. No.: 16/493,490

(22) PCT Filed: Mar. 13, 2018
(86) PCT No.: PCT/IL2018/050291

§ 371 Date: Sep. 12, 2019

Related U.S. Application Data
(60) Provisional application No. 62/470,411, filed on Mar. 13, 2017.

(51) Int. Cl. A21D 10/00; A23D 9/00; A23L 27/20; A21D 2/16; A21D 2/18; A21D 2/04

(52) U.S. Cl. CPC A21D 10/002; A23D 9/00; A21D 2/04; A21D 2/16; A21D 2/181; A23L 27/206

(57) ABSTRACT

The present invention provides mixtures comprising flour, dried powdered palm fat and salt, wherein the flour and the fat are in a proportion that ranges from 100:45-55 by weight. Dough produced from the mixtures, as well as methods for producing short crust pastries are also provided.

### FIELD OF INVENTION

The present invention relates to baking mixes.

### BACKGROUND OF THE INVENTION

Short-crust pastry dough is a fat rich, low water baking dough. The high fat and low water content of the dough, in addition to shortening mixing time, also reduces the development of gluten networks and produces a crisp, crumbling pastry. Such dough is used in kitchens throughout the world to produce diverse baked items such as pie crusts, cookies, tarts and quiches.

Instant baked goods mixes have existed for over 60 years. Such mixes, requiring the baker to add only water, or in some cases, water and eggs or fat, simplify the baking process while also cutting the preparation time and increasing the uniformity of the baked good. Nevertheless, most such mixes produce a low or medium fat final product due to the difficulty in integrating large quantities of fat into a dry, pourable mix. A short crust pastry dough mix requires a high percentage of dry fat that can be integrated uniformly into a pourable mix, while also retaining a pleasing butter-like flavor. Such a mix, that consistently provides a crisp, crumbling, buttery pastry when baked is still needed.

### SUMMARY OF THE INVENTION

The present invention provides mixtures comprising white flour, spray dried powdered palm fat and salt, a method of producing dough from those mixes, and the dough so produced.

According to the first aspect, there is provided a mixture comprising: flour, spray-dried powdered palm fat, and salt, wherein the flour and the fat are in a proportion that ranges from 100:45-55 by weight.

In some embodiments, the flour is soft-wheat flour. In some embodiments, the flour is white soft wheat flour.

In some embodiments, the flour and the salt are in a proportion that ranges from 100:0.1-2.

In some embodiments, the spray-dried powered palm fat comprises 10-30% stabilizers, by weight. In some embodiments, the spray-dried powdered palm fat is in the form of particles. In some embodiments, a median size of the particles varies within a range of less than ±20%.

In some embodiments, the mixture further comprises at least one flavoring agent. In some embodiments, the flavoring agent is selected from the group consisting of malt, butter flavor, cocoa powder, chocolate flavor, hazelnut flavor, citrus zest, vanilla, pumpkin flavor, and a combination thereof. In some embodiments, the at least one flavoring agent is selected from diastatic malt and butter flavor. In some embodiments, the flour and the flavoring agent are present in a proportion that ranges from 100:0.01-2 by weight.

In some embodiments, the mixture further comprises at least one rising agent. In some embodiments, the rising agent is selected from the group consisting of sodium bicarbonate, sodium acid pyrophosphate (SAPP), calcium carbonate, sodium aluminum phosphate (SALP), mono-calcium phosphate (MCP) and a combination thereof. In some embodiments, the at least one rising agent is selected from sodium bicarbonate and sodium acid pyrophosphate (SAPP). In some embodiments, the flour and the rising agent are present in a proportion that ranges from 100:0.01-0.5, by weight.

In some embodiments, the mixture further comprises castor sugar. In some embodiments, the flour and the castor sugar are present in a proportion that ranges from 100:10-50, by weight.

By another aspect, there is provided a method for producing dough, the method comprising adding edible aqueous liquid to any of the mixtures of the invention. In some embodiments, the aqueous liquid is selected from the group consisting of: water, dairy liquid whipping cream, and non-dairy liquid whipping cream. In some embodiments, the amount of liquid added is relative to the amount of mixture in a proportion that ranges from 15-35:100, by weight.

By another aspect, there is provided a dough obtained by any of the methods of the invention. In some embodiments, the dough is short crust pastry dough.

Further embodiments and the full scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### DETAILED DESCRIPTION OF THE INVENTION

The present invention provides, in some embodiments, a mixture comprising flour, powdered palm fat, and salt. There is also provided methods for producing dough using the mixtures of the invention, as well as the dough which is produced.

By one aspect, the present invention provides a mixture comprising: white soft-wheat flour, spray-dried powdered palm fat and salt, wherein said flour and said fat are in a proportion that ranges from 100:45-55 by weight.

The term “soft-wheat flour” as used herein, refers to a low-protein, specifically low-gluten, flour produced from wheat. It is sometimes also referred to as cake flour or pastry flour. Typically, but not exclusively, protein levels in such flour are between 7-9%.

The term “spray-dried powdered palm fat” as used herein refers to the solid fat that can be extracted from palm oil at room temperature that has been dried and powdered such that it can be integrated into a dry mixture. In some embodiments, the process of drying and powdering requires the addition of stabilizers to the fat.

In some embodiments, the powdered palm fat comprises at least 70%, 75%, 80%, 85% or 90% palm fat by weights. Each possibility represents a separate embodiment of the present invention. In some embodiments, the powdered palm fat comprises up to 30%, up to 25%, up to 20%, up to 15%, or up to 10% stabilizers by weight. Each possibility represents a separate embodiment of the present invention. In some embodiments, the powdered palm fat comprises 10-30% stabilizers by weight. In some embodiments, the stabilizers are selected from, without being limited thereto, milk proteins, maltodextrins, glucose syrup from wheat, glucose syrup from maize, and modified starch E1450. In some embodiments, the stabilizers are glucose syrup from wheat, glucose syrup from maize, and modified starch E1450. In some embodiments, the powdered palm fat further comprises an anticaking agent. In some embodiments, the anticaking agent is silicon dioxide.

In some embodiments, powdered palm fat is in the form of particles. In some embodiments, the median size of the particles varies within a range of less than ±40%, ±30%, ±20%, or ±10%. Each possibility represents a separate embodiment of the present invention. In some embodiments, the median size of the particles varies within a range of less than ±20%. In some embodiments, the powdered palm fat is the MOKA FP high fat powder (MOKATE Ingredients, Poland).

In some embodiments, the flour and fat are in a proportion that ranges from 100:40-70, 40-65, 40-60, 40-55, 40-50, 45-70, 45-65, 45-60, 45-55, 45-50, 50-70, 50-65, 50-60, or 50-55 by weight. Each possibility represents a separate embodiment of the present invention. In some embodiments, the flour and fat are in a proportion that ranges from 100:45-55 by weight.

In some embodiments, the flour and the salt are in a proportion that ranges from 100:0.1-3, 0.1-2.9, 0.1-2.8, 0.1-2.7, 0.1-2.6, 0.1-2.5, 0.1-2.4, 0.1-2.3, 0.1-2.2, 0.1-2.1, 0.1-2.0, 0.1-1.9, 0.1-1.8, 0.1-1.7, 0.2-3, 0.2-2.9, 0.2-2.8, 0.2-2.7, 0.2-2.6, 0.2-2.5, 0.2-2.4, 0.2-2.3, 0.2-2.2, 0.2-2.1, 0.2-2.0, 0.2-1.9, 0.2-1.8, 0.2-1.7, 0.3-3, 0.3-2.9, 0.3-2.8, 0.3-2.7, 0.3-2.6, 0.3-2.5, 0.3-2.4, 0.3-2.3, 0.3-2.2, 0.3-2.1, 0.3-2.0, 0.3-1.9, 0.3-1.8, 0.3-1.7, 0.4-3, 0.4-2.9, 0.4-2.8, 0.4-2.7, 0.4-2.6, 0.4-2.5, 0.4-2.4, 0.4-2.3, 0.4-2.2, 0.4-2.1, 0.4-2.0, 0.4-1.9, 0.4-1.8, 0.4-1.7, 0.5-3, 0.5-2.9, 0.5-2.8, 0.5-2.7, 0.5-2.6, 0.5-2.5, 0.5-2.4, 0.5-2.3, 0.5-2.2, 0.5-2.1, 0.5-2.0, 0.5-1.9, 0.5-1.8, 0.5-1.7, 0.6-3, 0.6-2.9, 0.6-2.8, 0.6-2.7, 0.6-2.6, 0.6-2.5, 0.6-2.4, 0.6-2.3, 0.6-2.2, 0.6-2.1, 0.6-2.0, 0.6-1.9, 0.6-1.8, 0.6-1.7, 0.7-3, 0.7-2.9, 0.7-2.8, 0.7-2.7, 0.7-2.6, 0.7-2.5, 0.7-2.4, 0.7-2.3, 0.7-2.2, 0.7-2.1, 0.7-2.0, 0.7-1.9, 0.7-1.8, or 0.7-1.7 by weight. Each possibility represents a separate embodiment of the present invention. In some embodiments, the flour and the salt are in a proportion that ranges from 100:0.1-2.

In some embodiments, the mixtures of the invention further comprise at least one flavoring agent. The term “flavoring agent” as used herein refers to any substance naturally occurring or manmade which provides a new desirable flavor or enhances an already existing desirable flavor. It will be understood by one skilled in the art that substances that provide or cause an unpleasant or “off flavor” are not considered flavoring agents. An “off flavor” may depend on the individual tasting the flavor, but such flavors can regularly be discerned by one skilled in the art.

In some embodiments, the flavoring agent is selected from, without being limited thereto, malt, butter flavor, cocoa powder, chocolate flavor, hazelnut flavor, citrus zest, vanilla, pumpkin flavor and a combination thereof. In some embodiments, the flavoring agent is malt and butter flavor.

In some embodiments, the flour and the flavoring agent are present in a proportion that ranges from 100:0.1-3, 0.1-2.9, 0.1-2.8, 0.1-2.7, 0.1-2.6, 0.1-2.5, 0.1-2.4, 0.1-2.3, 0.1-2.2, 0.1-2.1, 0.1-2.0, 0.1-1.9, 0.1-1.8, 0.1-1.7, 0.2-3, 0.2-2.9, 0.2-2.8, 0.2-2.7, 0.2-2.6, 0.2-2.5, 0.2-2.4, 0.2-2.3, 0.2-2.2, 0.2-2.1, 0.2-2.0, 0.2-1.9, 0.2-1.8, 0.2-1.7, 0.3-3, 0.3-2.9, 0.3-2.8, 0.3-2.7, 0.3-2.6, 0.3-2.5, 0.3-2.4, 0.3-2.3, 0.3-2.2, 0.3-2.1, 0.3-2.0, 0.3-1.9, 0.3-1.8, 0.3-1.7, 0.4-3, 0.4-2.9, 0.4-2.8, 0.4-2.7, 0.4-2.6, 0.4-2.5, 0.4-2.4, 0.4-2.3, 0.4-2.2, 0.4-2.1, 0.4-2.0, 0.4-1.9, 0.4-1.8, 0.4-1.7, 0.5-3, 0.5-2.9, 0.5-2.8, 0.5-2.7, 0.5-2.6, 0.5-2.5, 0.5-2.4, 0.5-2.3, 0.5-2.2, 0.5-2.1, 0.5-2.0, 0.5-1.9, 0.5-1.8, 0.5-1.7, 0.6-3, 0.6-2.9, 0.6-2.8, 0.6-2.7, 0.6-2.6, 0.6-2.5, 0.6-2.4, 0.6-2.3, 0.6-2.2, 0.6-2.1, 0.6-2.0, 0.6-1.9, 0.6-1.8, 0.6-1.7, 0.7-3, 0.7-2.9, 0.7-2.8, 0.7-2.7, 0.7-2.6, 0.7-2.5, 0.7-2.4, 0.7-2.3, 0.7-2.2, 0.7-2.1, 0.7-2.0, 0.7-1.9, 0.7-1.8, or 0.7-1.7 by weight. Each possibility represents a separate embodiment of the present invention. In some embodiments, the flour and the flavoring agent are present in a proportion that ranges from 100:0.01-2 by weight.

In some embodiments, the mixtures of the invention further comprise at least one rising agent. The term “rising agent” as used herein, refers to a naturally occurring or manmade substance that increases the rising of the dough or pastry. In some embodiments, the increased rising is caused by increased gas production in the dough either before or during baking. In some embodiments, the gas produced is carbon dioxide. In some embodiments, the increased rising is caused by alterations in the structure of the dough such that more of the gases produced before or during baking are retained within the dough.

In some embodiments, the rising agent is selected from, without being limited thereto, sodium bicarbonate, sodium acid pyrophosphate (SAPP), calcium carbonate, sodium aluminum phosphate (SALP), mono-calcium phosphate (MCP) and a combination thereof. In some embodiments, the rising agent is sodium bicarbonate and sodium acid pyrophosphate (SAPP).

In some embodiments, the flour and the rising agent are present in a proportion that ranges from 100:0.01-0.8, 0.01-0.7, 0.01-0.6, 0.01-0.5, 0.01-0.4, 0.01-0.3, 0.05-0.8, 0.05-0.7, 0.05-0.6, 0.05-0.5, 0.05-0.4, 0.05-0.3, 0.1-0.8, 0.1-0.7, 0.1-0.6, 0.1-0.5, 0.1-0.4, 0.1-0.3, 0.15-0.8, 0.15-0.7, 0.15-0.6, 0.15-0.5, 0.15-0.4, 0.15-0.3, 0.2-0.8, 0.2-0.7, 0.2-0.6, 0.2-0.5, 0.2-0.4, or 0.2-0.3 by weight. Each possibility represents a separate embodiment of the present invention. In some embodiments, the flour and the rising agent are present in a proportion that ranges from 100:0.01-0.5, by weight.

In some embodiments, the mixtures of the invention further comprise castor sugar. The term “castor sugar” as used herein, refers to superfine granulated sugar. It is also sometimes known as bar sugar. Castor sugar is finer than granulated sugar, but not as fine as powdered sugar. Its texture is also slightly thicker than confectioner's sugar. Castor sugar can be made by pulverizing granulated sugar. In some embodiments, the castor sugar is refined castor sugar. In some embodiments, the castor sugar is unrefined castor sugar.

In some embodiments, the flour and the castor sugar are present in a proportion that ranges from 100:5-60, 5-55, 5-50, 5-45, 5-40, 10-60, 10-55, 10-50, 10-45, 10-40, 15-60, 15-55, 15-50, 15-45, or 15-40, by weight. Each possibility represents a separate embodiment of the present invention. In some embodiments, the flour and the castor sugar are present in a proportion that ranges from 100:10-50, by weight.

By another aspect, there is provided a method for producing dough, the method comprising adding an aqueous liquid to any of the mixtures of the invention. In some embodiments, the dough is short crust pastry dough.

In some embodiments, the method further comprises mixing the liquid into the mixture until the result is uniform in consistency. In some embodiments, the method further comprises cooling of the dough after the adding and/or after the mixing.

It should be understood, by one skilled in the art, that an aqueous liquid will be a non-toxic, potable, water-based liquid that is suitable for human consumption. As a non-limiting example, an aqueous liquid may be any one of water, juice, milk, cream, or a combination thereof. Such a liquid, for example, may be carbonated or non-carbonated, may be colored or colorless, may be clear or opaque. In some embodiments, the aqueous liquid is selected from the group consisting of: water, dairy liquid whipping cream, and non-dairy liquid whipping cream. In some embodiments, whipping cream is heavy cream.

In some embodiments, the amount of liquid added is relative to the amount of flour in the mixture in a proportion that ranges from 30-80, 30-75, 30-70, 30-60, 30-50, 30-45, 30-40, 35-80, 35-75, 35-70, 35-60, 35-50, 35-45, 35-40:150, by weight. Each possibility represents a separate embodiment of the present invention. In some embodiments, the amount of water added is relative to the amount of flour in the mixture in a proportion of about 40:150. In some embodiments, the amount of whipping cream added is relative to the amount of flour in the mixture in a proportion of about 73.2:100. In some embodiments, this ratio is irrespective of sugar content in the mixture.

In some embodiments, the amount of liquid added is relative to the amount of mixture in a proportion that ranges from 10-35, 15-35, 20-35, 10-30, 10-27, 15-30, 20-30,10-25, 5-25, or 20-25 :100, by weight. Each possibility represents a separate embodiment of the present invention. In some embodiments, the amount of liquid added is relative to the amount of mixture in a proportion that ranges from 15-35:100, by weight. In some embodiments, the mixture lacks sugar and more liquid is required. In some embodiments, the mixture contains sugar and less liquid is required. In some embodiments, the mixture contains no sugar and the proportion of water to mixture is between 15-20, 15-19, 15-18, 15-17, 16-20, 16-19, 16-18, 17-20, 17-19 or 17-18:100, by weight. Each possibility represents a separate embodiment of the present invention. In some embodiments, the mixture contains no sugar and the proportion of water to mixture is about 17.8:100, by weight. In some embodiments, the mixture contains sugar and the proportion of water to mixture is between 15-20, 15-19, 15-18, 15-17, 16-20, 16-19, 16-18, 17-20, 17-19 or 17-18:100, by weight. Each possibility represents a separate embodiment of the present invention. In some embodiments, the mixture contains sugar and the proportion of water to mixture is about 15.6:100, by weight.

In some embodiments, the mixture contains no sugar and the proportion of whipping cream to mixture is between 25-40, 27-40, 29-40, 30-40, 31-40, 25-38, 27-38, 29-38, 30-38, 31-38, 25-36, 27-36, 29-36, 30-36, 31-36, 25-34, 27-34, 29-34, 30-34, or 31-34:100, by weight. Each possibility represents a separate embodiment of the present invention. In some embodiments, the mixture contains no sugar and the proportion of whipping cream to mixture is about 32:100, by weight. In some embodiments, the mixture contains sugar and the proportion of whipping cream to mixture is between 15-30, 17-30, 19-30, 20-30, 21-30, 23-30, 15-28, 17-28, 19-28, 20-28, 21-28, 23-28, 15-26, 17-26, 19-26, 20-26, 21-26, or 23-26:100, by weight. Each possibility represents a separate embodiment of the present invention. In some embodiments, the mixture contains sugar and the proportion of whipping cream to mixture is about 24:100.

By another aspect, there is provided a dough obtained by any of the methods of the invention.

As used herein the term “about” refers to ±10%.

The terms “comprises”, “comprising”, “includes”, “including”, “having” and their conjugates mean “including but not limited to”. The term “consisting of” means “including and limited to”. The term “consisting essentially of” means that the composition, method or structure may include additional ingredients, steps and/or parts, but only if the additional ingredients, steps and/or parts do not materially alter the basic and novel characteristics of the claimed composition, method or structure.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

It is noted that as used herein and in the appended claims, the singular forms “a,” “an,” and “the” include plural referents unless the context clearly dictates otherwise. Thus, for example, reference to “a polynucleotide” includes a plurality of such polynucleotides and reference to “the polypeptide” includes reference to one or more polypeptides and equivalents thereof known to those skilled in the art, and so forth. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

As used herein the term “method” refers to manners, means, techniques and procedures for accomplishing a given task including, but not limited to, those manners, means, techniques and procedures either known to, or readily developed from known manners, means, techniques and procedures by practitioners of baking.

In those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination. All combinations of the embodiments pertaining to the invention are specifically embraced by the present invention and are disclosed herein just as if each and every combination was individually and explicitly disclosed. In addition, all sub-combinations of the various embodiments and elements thereof are also specifically embraced by the present invention and are disclosed herein just as if each and every such sub-combination was individually and explicitly disclosed herein.

Additional objects, advantages, and novel features of the present invention will become apparent to one ordinarily skilled in the art upon examination of the following examples, which are not intended to be limiting. Additionally, each of the various embodiments and aspects of the present invention as delineated hereinabove and as claimed in the claims section below finds experimental support in the following examples.

Various embodiments and aspects of the present invention as delineated hereinabove and as claimed in the claims section below find experimental support in the following examples.

### EXAMPLES

### Example 1: Selection of Basic Ingredients

Various experimental mixtures were tried in an effort to produce a dry, pourable powder that when mixed with liquid and then baked produces a pleasing short-crust pastry. Mixtures were judged based on the ease of mixing all the ingredients, ability to produce a dry pourable powder, and the appearance and taste of the final pastry. As with most baked goods, flour was the primary ingredient. Soft white wheat flour was selected as the flour to be used, due to its low gluten content which will produce a crisp and flaky product when baked. Use of hard flour (high gluten) resulted in development of an extensive gluten network, and puffing during baking. Each experimental sample was based on 150 grams of flour, and all other ingredients were measured relative to the flour by weight.

Sugar was not required for producing a mix that produced crisp and flaky pastry. However, for sweet pastries it is essential. Use of granulated sugar caused a sandy feeling in the mouth, as low moisture levels in the dough resulted in sugar crystals that did not dissolve. Castor sugar was used instead and produced no such negative texture. 50 grams of castor sugar per 150 grams of flour was found to be ideal for sweet dough, although more or less can be used depending on the desired sweetness in the final pastry. For a salty dough, such as might be used for quiches, no sugar was added.

Salt was required for producing proper taste in the dough, however, less salt was required when sugar was added. By trial and error, it was found that 1.2 grams of salt for sweet dough, and 2.5 grams for sugarless dough were ideal. However, once again, the mount of salt could be varied as required by the specific taste preference of the baker.

### Example 2: Selection of the Fat

Different types of fats were tried in order to determine the best option.

Standard short-crust dough is made with butter. Butter consists of ˜80% fat and ˜20% water and milk solids. Butter's melting point is ˜30 degrees Celsius, which illustrates the two main constrains on the fat used in pastry:
1. the melting point should be lower than or equal to body temperature, in order to melt while the pastry is chewed, and
2. the melting temperature should be above room temperature, so the dough will be solid during lamination and handling (too liquid a dough cannot be formed into pastry).

To help with this second constraint, short-crust dough should generally be refrigerated before handling in order to keep it solid. Pastry made with butter is very brittle. This allows it to be chewed easily, with no hard areas, and to break into small granules that melt in the mouth, all while the center of the dough is well baked.

Butter usage in standard short-crust dough is 100 grams of butter to 150 grams flour. Since butter is only ˜80% fat this is equivalent to 80 grams of fat to 150 grams of flour. Butter cannot be used in producing a dry pourable mix, as it contains ˜20% liquid and also would go rancid if stored without refrigeration.

Margarine is designed to mimic butter in baking and thus was tested as a possible fat in short-crust dough. Margarine remains solid at room temperature resulting in easier workability than butter, but still melts in the mouth while eating. However, overall, pastry made with margarine was worse than pastry made with butter, and required more chewing in order to break it into granules. Margarine, like butter, contains 80% fat and therefore 100 grams was used for 150 grams of flour. Margarine had similar problems being integrated into a dry pourable mix.

High melting point palm fat, called stearin, is the solid fraction of palm oil, and is solid at room temperature. Stearin in a solid brick form did not produce dough under normal conditions, as it was too hard to mix in a standard mixer. Stearin in semi-powder form could be incorporated into dough, however it still retained a bead-like particulate form in the dough, and during baking a fraction of it melted out of the dough and left pores in the pastry. Further, the resulting pastry was very hard and unchewable, and very pale in color. In addition, due to the high melting point of stearin (above body temperature), the fat did not melt well in the mouth and left a very unpleasant, waxy feeling.

Refined palm oil has a melting point close to, but slightly below, butter. At room temperature, it can be either a soft solid or liquid, depending on the precise ambient temperature. As palm oil contains 100% fat, 80 grams were used per 150 grams of flour. An additional 20 grams of water was added at the time of liquid addition. The result was a good dough which was very similar to that produced with butter, with a good mouth feel and texture. However, since palm oil is semi solid to liquid at room temperature, it was very difficult to incorporate it with flour to create a dry pourable mix in the lab.

Powdered butter, which is butter dried up into a pourable powder, was tested as a substitute to semi-liquid fat. Powdered butter is composed of 80% butter fat and 20% stabilizers (mostly milk proteins and maltodextrins). A preliminary test was conducted and even though powdered butter contains the same amount of fat as butter (per 100 grams), it was concluded that its low moisture level (˜0% instead of 20% in butter) required the usage of the same weight of powdered butter as regular butter and addition of extra water at the time of liquid addition. Powdered butter produced pastry that was harder and less crumbly then butter pastry, with a soft unbaked center, and was much darker in color.

Finally, a spray-dried powdered palm fat was tested. The powder contained 80% refined palm oil and 20% stabilizers. The use of powdered oil made it possible to dry-mix the product to create a dry pourable mixture. The resulting pastry was comparable to that produced with palm oil or butter, being a soft, easy to chew, crumbling pastry that melted in the mouth without a residual waxy feeling. Additionally, dough handling was better than butter-dough, as it was more flexible and required less refrigeration; nevertheless, best results still required some cooling of the dough. As the fat content in the powdered palm fat was comparable to powdered butter, it was hypothesized that 100 grams might be needed per 150 grams of flour. However, experiments showed that 80 grams worked well and amounts as low as 70 grams could still produce good pastry. 75 grams was found to be ideal as it allowed for better pricing and quality margins. In addition, mixtures with powdered palm fat were tested for accelerated shelf life and showed no sign of oxidation or rancidity.

### Example 3: Determination of Moisture Requirements

During the testing of various fats, it became clear that a correct moisture level in the dough is crucial for creating a good final pastry. Too low a quantity of added liquids resulted in a dough that did not combine and could not be further processed; while too much liquid resulted in a pastry that was not flaky and crumbly, and that did not bake evenly.

The ideal amount of liquid was determined to be around 40 grams of water to 150 grams of flour. Recipes using butter generally call for 50 grams of total liquid (30 grams of liquid added, plus 20 grams from the butter itself), which theoretically would necessitate 50 grams of liquid when using powdered palm fat (which contains no water). However, empirical testing found the actual best amount of water was lower than theorized.

Samples of the mixture were sent to outside patisserie experts for cross determination of ideal liquid amounts for 300 grams of final mix (the amount needed for one medium tart/quiche). It was found that different amounts of liquid were required depending on whether sugar was present in the dough. Since sugar can account for a large portion of the weight of the mix, mixtures without sugar have more flour by weight and thus require more liquid. For sweet pastry, the ideal amount of water was found to be 47 grams for 300 grams of mix. For salty pastry (with no or little sugar), the ideal amount of water was found to be 53.5 grams for 300 grams of mix.

Interestingly, it was found that using whipping cream (38% fat for dairy cream or 20% fat for non-dairy cream) in place of water produced even better flavor results. In the case of whipping cream, 60 grams per 250 grams sweet mix and 80 grams per 250 grams salty mix were found to be ideal. Use of cream was recommended for best results, while water gives adequate results for basic recipes.

Usage of eggs, whether whole or just yolks, did not produce palatable pastry. Similarly, use of milk was not advantageous in comparison to water.

### Example 4: Selection of Additives

Several additives were tested in order to produce an improved final product. The following additives were approved for inclusion in the final mix:
a) Butter flavor: Butter flavor was added in order to provide a more buttery flavor to the pastry, as no butter was used. The ideal amount of flavor was found, by taste test, to be about 0.1 grams to 150 grams of flour. As the amount used is a matter of taste, different suppliers may prefer different amounts.
b) Diastatic barley malt: Malt was used in order to “round” the butter flavor and mask unwanted artificial flavors. Several types of malt were tested, and diastatic malt was chosen because it was lightest in color. Other malts (such as aromatic barley malt) had better flavor, but caused darkening of the dough, which was perceived as less attractive in the final product. The ideal amount of diastatic barley malt was found to be 0.75 grams to 150 grams of flour.
c) Rising agents: Sodium bicarbonate and sodium acid pyrophosphate (SAPP) were added in small amounts to the mixture. Rising activity (releasing of carbon dioxide during baking) contributed to a softer texture of the pastry, while the amounts were low enough such that the pastry did not puff. The ideal amount of sodium bicarbonate was found to be 0.17 grams per 150 grams of flour for sweet dough and 0.14 grams for salty dough. This was done in order to compensate for the caramelization and hardening that sugar causes during baking. The ideal amount of sodium acid pyrophosphate was found to be 0.23 grams per 150 grams of flour for sweet dough and 0.18 grams for salty dough.

Several other additives were tested during development and ultimately not included in the final mix:
a) Emulsifiers: Bakery emulsifiers such as sodium stearoyl lactylate (SSL), glycerol mono-stearate (GMS) and diacetyl tartaric acid esters of monoglycerides (DATEM) were added in an attempt to produce better, softer texture and slow pastry drying. However, all these emulsifiers produced noticeable off-flavor in the pastry and did not positively contributed to the texture of the final product.
b) Relaxing agents: Relaxing agents weaken the gluten network, and theoretically would contribute to the crumbliness and short bite of the pastry. Protease enzyme, sodium metabisulphate and L-cysteine were tested as relaxing agents. However, no noticeable activity was found with low relaxer levels, and high levels created noticeable off flavors.
c) Starches: Various starches were tested as possible replacements for part of the flour, in order to disrupt gluten network formation while keeping the pastry starch network. The tested starches included native wheat starch, native corn starch, modified corn starches and rice starch. All starches resulted in very hard pastry and loss of all crumbliness.
d) Maltodextrins: Maltodextrins were tested as a replacement for sugar in salty mixtures. Maltodextrins though having much lower sweetness, provide the same structural role as sugar (bulking agents), allowing uniformity of both products. However, the texture quality of the final pastry with maltodextrins was inferior and thus they were not used.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

1. A mixture comprising: flour, dried powdered palm fat and salt, wherein said flour and said fat are in a proportion that ranges from 100:45-55 by weight.

2. The mixture of claim 1, wherein said flour is soft-wheat flour.

3. The mixture of claim 2, wherein said soft-wheat flour is white soft-wheat flour.

4. The mixture of claim 1, wherein said dried powdered palm fat is spray-dried powdered palm fat.

5. The mixture of claim 1, wherein said flour and said salt are in a proportion that ranges from 100:0.1-2.

6. The mixture of claim 1, wherein said dried powered palm fat comprises 10-30% stabilizers, by weight.

7. The mixture of claim 1, wherein said dried powdered palm fat is in the form of particles.

8. The mixture of claim 7, wherein a median size of said particles varies within a range of less than ±20%.

9. The mixture of claim 1, further comprising at least one flavoring agent.

10. The mixture of claim 9, wherein said flavoring agent is selected from the group consisting of malt, butter flavor, cocoa powder, chocolate flavor, hazelnut flavor, citrus zest, vanilla, pumpkin flavor, and a combination thereof.

11. The mixture of claim 10, wherein said at least one flavoring agent is selected from malt and butter flavor.

12. The mixture of claim 9, wherein said flour and said flavoring agent are present in a proportion that ranges from 100:0.01-2 by weight.

13. The mixture of claim 1, further comprising at least one rising agent.

14. The mixture of claim 13, wherein said rising agent is selected from the group consisting of sodium bicarbonate, sodium acid pyrophosphate (SAPP), calcium carbonate, sodium aluminum phosphate (SALP), mono-calcium phosphate (MCP) and a combination thereof.

15. The mixture of claim 13, wherein said at least one rising agent is selected from sodium bicarbonate and sodium acid pyrophosphate (SAPP).

16. The mixture of claim 13, wherein said flour and said rising agent are present in a proportion that ranges from 100:0.01-0.5, by weight.

17. The mixture of claim 1, further comprising castor sugar.

18. The mixture of claim 17, wherein said flour and said castor sugar are present in a proportion that ranges from 100:10-50, by weight.

19. A method for producing dough, the method comprising adding an aqueous liquid to the mixture of claim 1, optionally wherein said aqueous liquid is selected from the group consisting of: water, dairy liquid whipping cream, and non-dairy liquid whipping cream, further optionally wherein the amount of liquid added is relative to the amount of mixture in a proportion that ranges from 15-35:100, by weight.

20.-21. (canceled)

22. A dough obtained by the method of claim 19.

23. (canceled)
